(19) United States
(12) Patent Application Publication
(10) Pub. No.: US 2005/0085570 A1
(43) Pub. Date: Apr. 21, 2005

(54) Multi-functional silicon cement

(75) Inventors: Yu-Hung Kang, Kaohsiung (TW); Ti-Hu Huang, Kaohsiung (TW)

Correspondence Address: WILLIAM COLLARD;COLLARD & ROE, P.C., 1077 NORTHERN BOULEVARD, ROSLYN, NY, 11576, US

(73) Assignee: KANG'S BROTHER COMPANY LTD.

(21) Appl. No.: 10/686,297

(22) Filed: Oct. 15, 2003

(51) Int. Cl. C08K 3/34

(52) U.S. Cl. 524/2; 524/492

(57) ABSTRACT

A multi-functional silicon cement comprises a viscous component part and a powdered component part. The viscous component part contains methyl methacrylate, ethyl acrylate, buthyl acrylate, a surfactant, an activator, and water. The powdered component part contains the conventional cement and the refined silicon dioxide. The viscous component part and the powdered component part are mixed together along a specific amount of water to form a mortar or pasty substance. The pasty substance is sued to cover the wall surface.

### BACKGROUND OF THE INVENTION

The conventional cement is a powdered substance, which is made of the burned lime and clay, and is mixed with water and sand to make mortar for constructing walls, ceilings, and partitions of a building. The main function of the conventional cement is to provide the building with a basic mechanical support. In another words, the walls, ceilings, and partitions of the conventional cement are bit efficient in reducing the energy consumption of the building. The cost of operating an air-conditioning system and a heating system of the building has skyrocketed in recent years. Such a high-cost energy situation will be conceivably aggravated in the event that a global energy crisis comes about.

### SUMMARY OF THE INVENTION

The primary objective of the present invention is to provide a multi-functional silicon cement which can be used to patch or cover the surface of a wall, ceiling, or partition, so as to reinforce the function of the wall, ceiling, or partition.

In keeping with the principle of the present invention, the foregoing objective of the present invention is attained by a multi-functional silicon cement which is made up of a synthetic polymer, silicon dioxide, and the conventional cement. The silicon cement of the present invention is mixed with a specific amount of water to make mortar, which can be used to patch the surface of a wall, ceiling, partition, or the like. The silicon cement of the present invention can be further mixed with a specific amount of water to form a pasty mixture, which can be used to cover the surface of a wall, ceiling, partition, or the like.

As compared with the concrete cement, the silicon cement of the present invention has a relatively low thermal conductivity coefficient, a greater capability of preventing efflorescence, a relatively low roughness average, a better bearing capacity of thermal expansion and cold shrinkage effects and a greater anti-aging effect. As compared with the conventional wall paints, the silicon cement of the present invention is higher in flash point, more resistant to a hot or cold environment and greater in waterproof. Moreover, the silicon cement of the present invention is environmentally friendly.

The features and the advantages of the present invention will be more readily understood upon a thoughtful deliberation of the following detailed description of the present invention and the results of the comparative experiments.

### DETAILED DESCRIPTION OF THE INVENTION

A multi-functional silicon cement of the present invention comprises a primary constituent and a secondary constituent.

The primary constituent is a white viscous substance and is made up of 3.8% by weight of methyl methacrylate, 7.2% by weight of ethyl acrylate, 37% by weight of butyl acrylate, 0.8% by weight of surfacetant, 1.2% by weight of an activator, and 50% by weight of water. The primary constituent has a viscosity ranging from 1000 to 2000 cps, by preference 1300 cps, an extension rate of 435%, a tensile strength of 7.2 kg/cm and a PH value ranging from 7.5 to 8.5.

The secondary constituent is made up of the conventional cement and silicon dioxide (silica) which is refined at 1600° C. and has a thermal conductivity coefficient smaller than 0.046 kcal/mh° C.

In application, the silicon cement of the present invention is prepared in such a manner that 15 kg of the primary constituent, 12.5 kg of the conventional cement, and 2.5 kg of the silicon dioxide are mixed together to term a mixture having a total weight of 30 kg. However, it must be noted here that 10% of water by weight of the mixture (30 kg) must be added to the primary constituent before the primary constituent is mixed with the secondary constituent. The primary constituent and the 10% of water must be thoroughly mixed by agitation before the primary constituent and the secondary constituent are mixed to form a mortar, which is used to patch the surface of a wall, ceiling, partition, roof, or the like. The primary constituent may be first mixed with 15-20% of water by weight of the mixture (30 kg) and then mixed with the secondary constituent to result in formation of a pasty substance, which is used to cover the surface of a wall, ceiling, partition, roof, or the like.

It must be noted here that a desired pigment may be added at such time when the primary constituent and the secondary constituent are mixed and agitated. As a result, the mortar or pasty substance so made has the desired color.

According to the experiments conducted a evaluate the performance of the multi-functional silicon cement of the present invention, the silicon cement of the present invention is superior to the conventional cement and the conventional wall paint in term of prevention of the water capillary action, thermal conductivity, carbon dioxide blocking efficiency, migration of soluble elements, resistance to acid rain, flash point, and resistance to a cold or hot element.

The advantage of the present invention are therefore readily apparent that the multi-functional silicon cement of the present invention is effective in reducing energy consumption of the building, improving the waterproof quality of the building, improving the fireproof quality if the building, and prolonging the longevity of the building. In addition, the silicon cement of the present invention is not environmentally hazardous. In short, the multi-functional silicon cement of the present invention is a cost-effective building material.

The invention described above is to be regarded in all respect as being illustrative and nonrestrictive. Accordingly, the present invention may be embodied in other specific forms without deviating from the spirit thereof. The present invention is therefore to be limited only by the scopes of the following claims.

1. A multi-functional silicon cement comprising:
a primary constituent of a viscous form and made of 3.8% by weight of methyl methacrylate, 7.2% by weight of ethyl acrylate, 37% by weight of butyl acrylate, 0.8% by weight of a surfactant, 1.2% by weight of an activator, and 50% by weight of water; and
a secondary constituent of a powdered form and formed of a conventional cement and a refined silicon dioxide;
said silicon cement prepared in such a way that 15 kg of said primary constituent, 12.5 kg of the conventional cement of said secondary constituent, and 2.5 kg of the refined silicon dioxide of said secondary constituent are mixed together to form a mixture having a weight of 30 kg wherein said mixture forms a mortar.

2. The silicon cement as defined in claim 1, wherein said mixture is mixed with 15-20% of water by weight of said mixture to form a pasty substance.

3. The silicon cement as defined in claim 1, wherein said mixture contains a pigment.

4. The silicon cement as defined in claim 1, wherein said primary constituent has a viscosity ranging from 1000 to 2000 cps, an extension rate of 435%, a tensile strength of 7.2 kg/cm², and a PH value ranging from 7.5-8.5.

5. The silicon cement as defined in claim 1, wherein said refined silicon dioxide has a thermal conductivity coefficient smaller than 0.046 kcal/mh° C.

6. A multi-functional silicon cement comprising:
a primary constituent of a viscous form comprising approximately 3.8% by weight of methyl methacrylate, approximately 7.2% by weight of ethyl acrylate, approximately 37% by weight of butyl acrylate, approximately 0.8% by weight of a surfactant, approximately 1.2% by weight of an activator, and approximately 50% by weight of water; and
a secondary constituent of a powdered form comprising a conventional cement and a refined silicon dioxide;
wherein said primary constituent and said secondary constituent are mixed together to form a mortar.
